(19) United States
(12) Patent Application Publication
(10) Pub. No.: US 2025/0335223 A1
(43) Pub. Date: Oct. 30, 2025

(54) HARDWARE EMULATOR AND EMULATION SYSTEM INCLUDING HARDWARE EMULATOR

(71) Applicant: SAMSUNG ELECTRONICS CO., LTD., Suwon-si (KR)

(72) Inventors: Carlos Cristiano DE JESUS ALCANTARA, Suwon-si (KR); Chang-Woo Shin, Suwon-si (KR); Anes Ju, Suwon-si (KR); Kitae Park, Suwon-si (KR)

(73) Assignee: SAMSUNG ELECTRONICS CO., LTD., Suwon-si (KR)

(21) Appl. No.: 19/097,553

(22) Filed: Apr. 1, 2025

(30) Foreign Application Priority Data
Apr. 29, 2024 (KR) 10-2024-0056677
Jul. 19, 2024 (KR) 10-2024-0095684

(51) Int. Cl. G06F 9/455

(52) U.S. Cl. CPC G06F 9/45504

(57) ABSTRACT

A hardware emulator and an emulation system including the hardware emulator are provided. The hardware emulator includes an artificial neural network-based reconstruction model configured to reconstruct dynamics of a dynamical system based on input data and a memristor-based circuit configured to emulate state space representation of the dynamical system based on the reconstruction model.

### CROSS-REFERENCE TO RELATED APPLICATIONS

This application is based on and claims priority under 35 USC § 119(a) from Korean Patent Application No. 10-2024-0056677 filed on Apr. 29, 2024 and Korean Patent Application No. 10-2024-0095684, filed on Jul. 19, 2024, in the Korean Intellectual Property Office, the entire disclosure of which is incorporated herein by reference for all purposes.

### BACKGROUND

### 1. Field

The disclosure relates to a hardware emulator and an emulation system including the hardware emulator.

### 2. Description of Related Art

In neuromorphic engineering, analog integrated circuits are used to mimic the network structure and functions of a biological nervous system. Recently, neuromorphic engineering is expanding to include, for example, the use of integrated circuits to fully mimic the structure and functions of the brain in an electronic system, as well as understand some operating principles of the brain and implement a system applying the same.

For example, a neuromorphic electronic device may be used to reproduce a structure and functions of a natural neuronal network (NNN) of a brain as close as possible. Moreover, the neuromorphic electronic device may reflect connections of a large number of nerve cells (neurons) and each intensity of connection.

### SUMMARY

According to an aspect of the disclosure, there is provided a hardware emulator including: a reconstruction model based on an artificial neural network, the reconstruction model configured to reconstruct a dynamic system based on input data; and a memristor-based circuit configured to emulate state space representation of the dynamic system based on the reconstruction model.

The reconstruction model may be further configured to reflect one or more features of the dynamic system in the memristor-based circuit by approximating the artificial neural network based on a differential equation.

The reconstruction model may be further configured to approximate the artificial neural network based on a hidden state of the artificial neural network.

The reconstruction model may be further configured to reconstruct a geometric feature of the input data.

The hardware emulator may be configured to emulate the state space representation based on an ordinary differential equation (ODE) approximated by the reconstruction model.

The hardware emulator may be further configured to: perform emulation to find initial values of elements of the memristor-based circuit based on the ODE, and fine-tune the elements in real-time based on the initial values of the elements.

The hardware emulator may be further configured to iteratively perform fine-tuning on the elements until fidelity of the emulation satisfies a criterion.

The hardware emulator may be further configured to emulate the state space representation by flux control using at least one of a hardware oscillator or a cellular neural network.

The hardware emulator may be further configured to emulate the state space representation by mapping a hidden state of the artificial neural network onto the cellular neural network.

The hardware emulator may be further configured to fine-tune elements of the memristor-based circuit using a set of normalized differential equations by a chaotic attractor implemented by the hardware oscillator.

The artificial neural network may be trained based on temporal data and the state space representation as a portion of a loss function.

The hardware emulator may be configured to reflect a dynamic behavior of the dynamic system in the memristor-based circuit based on an ordinary differential equation (ODE) approximated in the reconstruction model as an input.

The hardware emulator may be configured to reconstruct temporal dynamics of the input data using the artificial neural network, which maintains memory about the input data.

The hardware emulator may be configured to reflect one or more features of the dynamic system in the memristor-based circuit based on a hidden state of the artificial neural network that captures previous input data of the input data.

The input data may include at least one of single-modal neural data or multi-modal neural data.

According to another aspect of the disclosure, there is provided an emulation system including: a control circuit including a plurality of control elements including a programmable electronic component, the control circuit configured to adjust control of the emulation system in real-time to replicate an operation of neural data by using the plurality of control elements; and a memristor-based hardware emulator configured to emulate one or more features in the neural data based on the control of the emulation system by the control circuit.

The control circuit may be further configured to perform fine-tuning on the memristor-based hardware emulator by changing parameters of the plurality of control elements until fidelity of emulation for the neural data exceeds a reference value.

The plurality of control elements may include at least one of a complementary metal-oxide-semiconductor (CMOS) resistor, a varactor, or a transistor.

The emulation system may further include an auxiliary circuit configured to perform at least one of power management, communication, or auxiliary communication on at least one of the programmable electronic component or a memristor-based circuit of the memristor-based hardware emulator.

The emulation system may be include in at least one of a wafer monitoring device, a video synthesis and analysis device, an audio synthesis and analysis device, a robot device, a home appliance product, or a communication device.

According to another aspect of the disclosure, there is provided an operating method of a hardware emulator including a reconstruction model based on an artificial neural network and a memristor-based circuit, the operating method including: reconstructing a dynamic system based on input data by the reconstruction model based on the artificial neural network; and emulating a state space representation of the dynamic system based on the reconstruction model by the memristor-based circuit.

Other features and aspects will be apparent from the following detailed description, the drawings, and the claims.

### BRIEF DESCRIPTION OF DRAWINGS

FIG. 1 is a block diagram of a hardware emulator according to an embodiment.

FIG. 2 is a diagram illustrating a reconfiguration process of a dynamical system using an artificial neural network.

FIG. 3 is a schematic diagram of an operation of a memristor-based circuit according to some embodiments.

FIG. 4 is a diagram illustrating an operation process of a hardware emulator according to an embodiment.

FIG. 5 is a block diagram of an emulation system according to an embodiment.

FIG. 6 is a diagram illustrating a production process of an emulation system according to an embodiment.

FIG. 7 is a diagram illustrating patch clamp data obtained by recording activities of individual neurons.

FIG. 8 is a diagram illustrating an operation of an emulation system according to an embodiment.

FIG. 9 is a flowchart illustrating an operating method of a hardware emulator according to an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed structural or functional description is provided as an example only and various alterations and modifications may be made to the examples. Accordingly, the embodiments are not to be construed as limited to the disclosure and should be understood to include all changes, equivalents, or replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The embodiments may be implemented as various types of products, such as, for example, a personal computer (PC), a laptop computer, a tablet computer, a smart phone, a television (TV), a smart home appliance, an intelligent vehicle, a kiosk, and a wearable device. Hereinafter, embodiments will be described in detail with reference to the accompanying drawings. In the drawings, like reference numerals are used for like elements. When describing the embodiments with reference to the accompanying drawings, like reference numerals refer to like elements and a repeated description related thereto will be omitted.

According to an embodiment, an artificial neural network system may implement an operation of a natural neural network. For example, the artificial neural network system may generate a neural network map of a brain that mimics a structure and a function of a brain by recording (measuring) and analyzing neural signals generated by biological neurons of the large natural neural network, such as a brain, and/or may function as a new neuromorphic processor through brain copy. For example, the neural network map of the brain may completely mimic the structure and the function of a brain.

The artificial neural network system may include a recording circuit and a programming circuit. For example, the recording circuit may be for measuring a membrane potential of an individual biological neuron of the natural neural network in real-time and the programming circuit for configuring an electronic neural network having the same structure as the natural neural network.

The electronic neural network may simulate an operation based on biological neurons of the natural neural network. The biological neurons refer to living nerve cells, not artificial neurons. Hereinafter, the terms “neurons” and “nerve cells” may be understood to have the same meaning. Here, “operations based on the biological neurons” may include, but is not limited to, synaptic connection analysis, ion channel analysis, ion channel current measurement, and measurement of effects of drugs on network connections and dynamics. However, examples are not limited thereto.

The recording circuit may include an electrode layer including a plurality of electrodes. The recording circuit may record (or measure) neural signals generated by biological neurons by contacting the biological neurons through the electrodes or may inject (or provide) a stimulation signal to the biological neurons. For example, the recording circuit may measure or read an electrical activity of all individual biological neurons of the natural neural network in real-time. For example, the recording circuit may measure or read the electrical activity of an individual biological neuron using a complementary metal-oxide-semiconductor (CMOS) nanoelectrode array (CNEA).

According to an embodiment, data measured by the recording circuit may be transmitted to the programming circuit and the data may be programmed as a synaptic weight of the corresponding electronic neural network. For example, a large volume of data measured by the recording circuit may be directly transmitted to the programming circuit in real-time and may be programmed as a synaptic weight of the corresponding electronic neural network based on mutual electrical activities between adjacent neurons.

The artificial neural network system may duplicate a connection structure of the natural neural network or may simulate an action by learning the large volume of data. The large volume of data may be collected by the natural neural network or may be artificially generated by the natural neural network.

For example, the artificial neural network system may generate the electronic neural network, which is able to simulate a response of a target neural network to a predetermined stimulus using the electrical activities of the biological neuron measured by the natural neural network without using information related to the number of non-measured neurons other than neurons measured by the target natural neural network and the connectivity between neurons. In an example case in which the target to be simulated is a human brain, it is ideal to collect data by conducting an experiment on a live and healthy brain for the natural neural network to simulate a response to a specific stimulus.

However, a neuroscience experiment involving a human body may cause various problems including, an ethical problem, a low throughput, and/or low reproducibility. For example, even in specific circumstances in which it is allowed to conduct an experiment on a human (e.g., a human patch clamp experiment), the number of measured neurons may be extremely limited and it may be difficult to conduct an experiment under a different circumstance or on a different input.

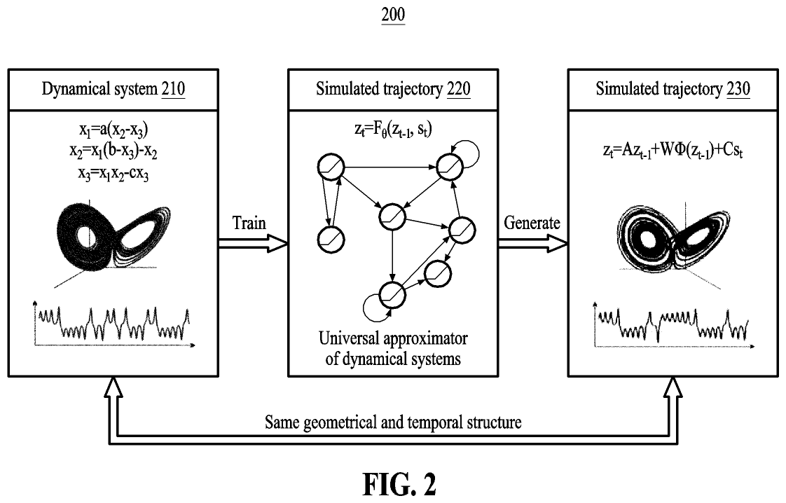

Accordingly, one or more embodiments of the disclosure a dynamical system, such as an emulator (e.g., a hardware emulator 100 of FIG. 2), that accurately duplicates dynamics of the brain, may be reconstructed and modeling of a relationship between parameters may be identified by the reconstructed dynamical system.

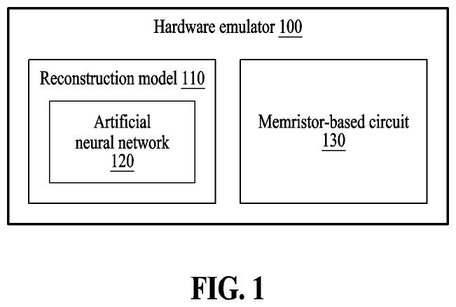

FIG. 1 is a block diagram of a hardware emulator according to an embodiment.

Referring to FIG. 1, according to an embodiment, a hardware emulator 100 may include a reconstruction model 110 and a memristor-based circuit 130.

The reconstruction model 110 may be based on an artificial neural network 120 and may reconstruct dynamics of a dynamical system based on input data.

The input data may be an input sequence or may be single data. The input data may include single-modal neural data and/or multi-modal neural data. The input data may include, but is not limited to, one or more of a geometric feature or a temporal feature related to a neuroscience experiment. The input data may be recorded data of a patch clamp, to be described below, but the example is not limited thereto.

The dynamical system may be, for example, a neuromorphic system or a system that models a dynamic motion. For example, the dynamical system may include, but is not limited to, blood pressure, temperature, and average (blood) flow velocity of a patient.

The artificial neural network 120 may include, for example, a recurrent neural network (RNN), but the example is not limited thereto. The artificial neural network 120 may be trained by using temporal data of the input data as an input and using reconstructed state space representation as at least a portion of a loss function. For example, the “temporal data” may correspond to data including a temporal feature of the input data.

The reconstruction model 110 may reflect (impose) dynamics of the dynamical system in the memristor-based circuit 130 by approximating the artificial neural network 120 by a differential equation. The reconstruction model 110 may, for example, approximate the artificial neural network 120 by regarding a hidden state of the artificial neural network 120 as a continuous function that changes over time. A reconstruction model 110 (e.g., an RNN model) may be trained to reconstruct a state space representation of a given system based on data. This may be separately performed from circuit design using a machine learning (ML) technique. In an example case in which the trained reconstruction model 110 exhibits small training and a training loss, the topology and a parameter of the trained network may be used to reverse-engineer the reconstruction model 110. In this case, the reconstruction model 110 may be simplified or may be converted into an equivalent form that allows to find an appropriated ordinary differentiated equation (ODE) representing a full system. However, the example is not limited thereto.

In an example case in which an oscillatory circuit is designed, the reconstruction model 110 may be approximated by a neural oscillator and may be modeled in the form of a graph. For example, each node that is modeled in the form of a graph may correspond to a memristor and one-to-one topology mapping may be performed on the architecture and the circuit.

The reconstruction model 110 may reconstruct a geometric feature of the input data. The trained reconstruction model 110 may match the entire geometrical representation of the state space.

The hardware emulator 100 may emulate a state space representation of the dynamical system based on the reconstruction model 110. For example, the “state space representation” may correspond to a mathematical model that expresses a physical system (e.g., a dynamical system) as a first-order differential equation of input, output, and state variables in a control system (e.g., the hardware emulator 100). The state space representation may display a variable as a vector to briefly represent multiple inputs, outputs, and states. The state space representation may be useful when the dynamical system is linear and varies over time. In other words, the state space representation may be a method of describing an operation of a dynamical system as a state variable and a derivative of the state variable and may briefly model and control a complex system through the state variable and the derivative of the state variable.

The state space representation may be, for example, represented as “[dot{\mathbf{x}}(t)=\mathbf{A}(t) \mathbf{x}(t)+\mathbf{B}(t) \mathbf{u}(t)]”. In this case, “\mathbf{x}(t)” may be a state vector and may represent a state variable of the system. “\mathbf{A}(t)” may be a state matrix and may describe a change in the state variable. “\mathbf{B}(t)” may be an input matrix and may represent an influence on an external input. “\mathbf{u}(t)” may be an input vector and may represent an input applied to the system.

As an example of the state space representation, a four-dimensional (4D) system may be considered. The 4D system may be represented by a fourth-order differential equation. In an example case in which the state variable is defined as (q_1, q_2, q_3, q_4), the state space representation of the 4D system may be, for example, “[\begin{align*}\dot{q}_1 &=q_2 \dot{q}_2 &=q_3 \dot{q}_3 &=q_4 \dot{q}_4 &=f(q_1, q_2, q_3, q_4, u) \end{align*}]”. In addition, the state space representation of the 4D system may be shown as a matrix, for example, “[\dot{\mathbf{q}}=\begin{bmatrix}0 & 1 & 0 & 0\0 & 0 & 1 & 0 \0 & 0 & 0 & 1 \0 & 0 & 0 & f(q_1, q_2, q_3, q_4, u) \end{bmatrix}\mathbf{q}+\begin{bmatrix}0 \0 0 \1 \end{bmatrix}u]”.

The hardware emulator 100 may emulate the state space representation using an ODE approximated by the reconstruction model 110. The hardware emulator 100 may emulate the state space representation by inputting the ODE approximated by the reconstruction model 110 to the memristor-based circuit 130.

For example, the ODE may be a term indicating a specific form of a differential equation and may be used for understanding and predicting an operation of the system. For example, the ODE may include, but is not limited to, a separable ODE, an exact ODE, a linear ODE, and a Bernoulli equation.

The hardware emulator 100 may reflect a dynamic behavior of the dynamical system in the memristor-based circuit 130 by using the ODE approximated by the reconstruction model 110 as an input. For example, the hardware emulator 100 may mimic or impose the dynamic behavior of the dynamical system in the memristor-based circuit 130.

The hardware emulator 100 may perform emulation (or simulation) to find initial values of elements of the memristor-based circuit 130 based on the ODE. Moreover, hardware emulator 100 may reflect (impose) a dynamic behavior of the dynamical system in the memristor-based circuit 130 by fine-tuning the elements (or parameters of the elements) of the memristor-based circuit 130 using the found initial values as a result of emulation in real-time. In this case, the elements of the memristor-based circuit 130 may include, for example, a resistor, a capacitor, an inductor, a memristor, and a memristor array. However, the example is not necessarily limited thereto.

The hardware emulator 100 may perform fine-tuning on the elements by changing parameters of the elements of the memristor-based circuit 130 until the fidelity of emulation for the input data exceeds a specific criterion. In this case, the “fidelity of emulation” may correspond to a concept that represents how similar an emulation (or simulation) environment provides an experience to reality. In an example case in which the emulator emphasizes an arbitrary feature, it may be considered that the fidelity of emulation is high and in an example case in which the emulator ignores the arbitrary feature, it may be considered that the fidelity of emulation is low.

For example, the hardware emulator 100 may emulate the state space representation by flux control using at least one of a hardware oscillator and a cellular neural network. For example, the hardware oscillator may be a Wien Bridge oscillator, but the example is not limited thereto. The Wien Bridge oscillator may correspond to one of a sinusoidal wave oscillator for generating a sinusoidal wave with constant frequency and amplitude.

The hardware emulator 100 may fine-tune the elements of the memristor-based circuit 130 by calculating the parameters of the elements using a set of normalized differential equations by a chaotic attractor implemented by the Wien bridge oscillator.

In this case, the “attractor” may correspond to a set of states representing the tendency of evolution of the system regardless of an initial condition in the dynamical system and may be a point in which the dynamical system converges to a specific area.

The chaotic attractor may be based on the chaos theory, which describes that a small change in a system may lead to an unpredictably significant consequence and may correspond to a fractal structure that represents how a state of a system (e.g., the dynamical system) changes over time, in other words, a dynamic action of the system. The chaotic attractor may be referred to as a “strange attractor” and may show a predetermined pattern and structure in the complex system.

The chaotic attractor may be implemented using the hardware oscillator (e.g., the Wien Bridge oscillator). For example, the hardware emulator may change an oscillation frequency by adjusting an amplitude of amplifier of the Wien Bridge oscillator, and may implement the chaotic attractor using the changed oscillation frequency.

The trajectory by the chaotic attractor may be periodic (or iterative) or chaotic (or unpredictable). The type of attractor may be divided into, for example, a fixed point attractor, a limit cycle attractor, a limit torus attractor, and/or a strange attractor. The fixed point attractor may correspond to a single point of a state space in which the system remains stable. The limit cycle attractor may correspond to a closed curve or loop that the system trajectory follows. The limit torus attractor may correspond to a high-dimensional version of a limit cycle. The strange attractor may correspond to a complex set having a fractal structure. The fractal structure may correspond to a structure in which similar patterns are repeated at different scales. The strange attractor may show sensitive dependency on an initial condition and a small difference of the initial condition may lead to a significantly different trajectory as the time elapses.

The “chaotic attractor” described herein may correspond to the strange attractor described above and may also be referred to as a “fractal structure”. The chaotic attractor may be characterized by unpredictability and complex actions and since a small change leads to a significantly different trajectory, long-term prediction may be difficult. For example, the chaotic attractor may be a mathematical structure generated in the dynamical system and may represent both order and chaos.

The “cellular neural network” may be a structure in which nerve cells (neurons), which are the basic unit of transmitting and processing information in the brain and nervous system, are connected to each other. The neurons may be connected through synapses and the synapse may process and transmit information by transmitting an electrochemical signal. The cellular neural network may perform various functions, for example, real-time image processing, by forming a complex neural network having local connection characteristics.

The hardware emulator 100 may emulate the state space representation by mapping a hidden state of the artificial neural network 120 onto the cellular neural network. The hardware emulator 100 may implement a hyperchaotic behavior using a memristor-based cellular neural network. The “hyperchaotic behavior” may refer to an abnormal operation or an abnormal feature of the system, and may indicate an operation that is more complex and difficult to predict than normal chaos.

The memristor may be an element configured to memorize and change a resistance value. For example, the memristor may correspond to an element configured to store memory by a change in a resistance value. The memristor may store and transmit information by imitating a synapse, which is a connector between brain cells.

According to an embodiment, in order to implement a hyperchaotic behavior by the memristor-based cellular network, the memristor to the neural network. For example, the cellular network may be implemented by connecting the memristor to the neural network. In this case, the network may imitate the connection between brain cells. The hardware emulator may change a synaptic weight by adjusting a resistance value of the memristor. The hardware emulator may store and transmit information by changing the synaptic weight. In this case, the hardware emulator may implement the hyperchaotic behavior of the cellular network by mapping a hidden state of an artificial neural network (e.g., the RNN) onto the cellular network.

The hardware emulator 100 may reconstruct temporal dynamics of the input data by the artificial neural network 120, which maintains the memory related to the input data. In addition, the hardware emulator 100 may impose dynamics on the memristor-based circuit by considering a hidden state of the artificial neural network 120, which captures previous input data of the input data.

In addition, the hardware emulator 100 may design a hardware-based neural network by matching a weight of the artificial neural network 120 to the memristor-based circuit 130.

The hardware emulator 100 may correspond to dedicated hardware designed to be used as an accelerator for processing (e.g., reconstructing dynamic behaviors of neural data) neuroscience data.

According to an embodiment, the hardware emulator 100 may be used for a neuroscience experiment as a robotic component in various application fields including dexterous manipulation, collaborative behavior, and legged robot engineering, or may be used as a hardware replica of a brain process for the development of artificial intelligence. In addition, the hardware emulator 100 may be used for a neurological diagnosis by accelerating the accuracy of an identification of a neurological disorder by the ability to process multi-modal data and queries of previous experiments or may be used for medication development for real-time screening by evaluating medication actions in various experimental circumstances. In addition, the hardware emulator 100 may be used as an educational platform for accelerating a learning process by allowing a researcher to find various experimental conditions by providing interactive emulation of a neuroscience experiment.

FIG. 2 is a diagram illustrating a reconfiguration process of a dynamical system using an artificial neural network. Referring to FIG. 2, a diagram 200 illustrates a process of generating a simulated trajectory 230 by a hardware emulator implemented by an RNN 220 trained based on a dynamical system 210.

The dynamical system 210 may be a system that changes over time and may have a characteristic that a current output is affected by not only a current input but also a previous input. In other words, the dynamical system 210 may be a system in which an output value at a certain time point depends on an input value at the time point as well as a previous input value. For example, an artificial neural network system may be affected not only bay a current input value but also a previous input and/or a weight. As described above, the system affected by a current input as well as a previous input may correspond to the dynamical system.

The artificial neural network may correspond to a system that changes over time while predicting and classifying an output by adjusting input data and a weight. Accordingly, the training of an RNN, such as the RNN 220, may be performed to minimize an error and adjust a weight using given input data and ground truth data.

For example, the hardware emulator may generate the simulated trajectory 230 of a neural recording by accurately reconstructing dynamics of temporal data using an artificial neural network, such as the RNN 220 or a transformer. For example, the simulated trajectory 230 by the hardware emulator may have a same geometric structure and a temporal structure as the dynamical system 210.

For example, the RNN 220 may accurately reconstruct dynamics of the temporal data by finding a pattern in high-dimensional data. For example, the high-dimensional data may be noisy data.

The RNN 220 may reconstruct data representing chaotic dynamics (e.g., functional magnetic resonance imaging, fMRI) and/or neural data obtained by electroencephalography (EEG) in an accurate scheme.

In an example case in which a set of given mathematical requirements exists in the input data, the hardware emulator may completely reconstruct the geometric structure and the temporal structure of the actual data by using an artificial intelligence (AI) architecture, such as the RNN 220. As a result, the trained RNN 320 may be an emulator of a neuroscience experiment. The RNN 220 may correspond to a universal approximator of the dynamical system.

In an embodiment, an emulator may be obtained by training the RNN 220 to reconstruct the geometric structure and the temporal structure of the dynamical system 210.

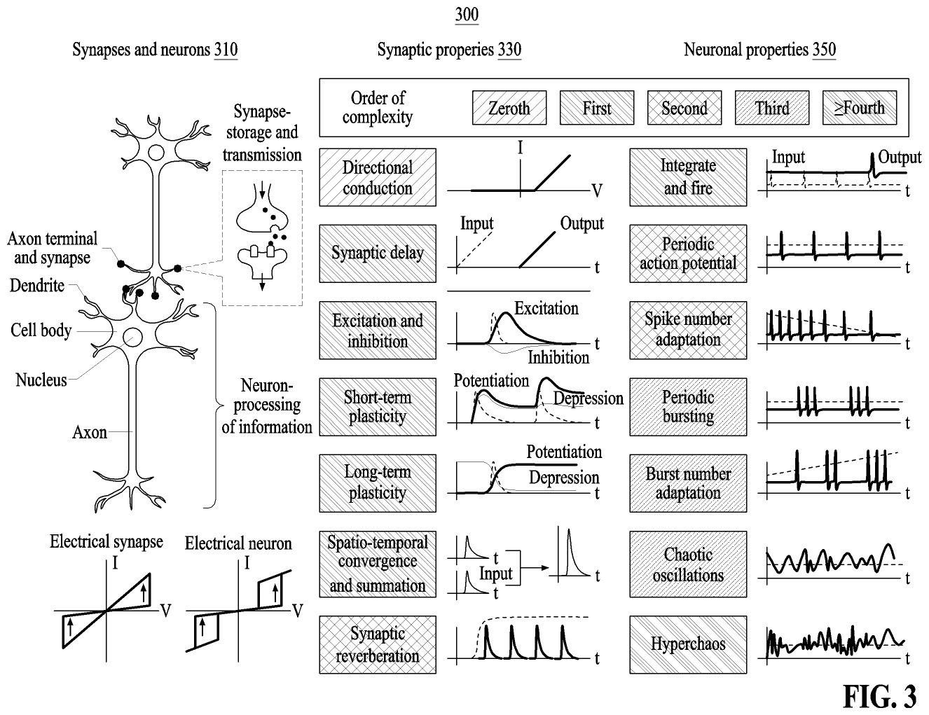

According to an embodiment, an emulator configured to reconstruct neural data by reconstructing chaotic oscillation and hyperchaos using the RNN 220 having fourth-order complexity (e.g., a neuron) may be built. An operation of the memristor-based circuit according to various complexities is further described with reference to FIG. 3 shown below.

The hardware emulator may provide better reconstruction, lower latency, and greater efficiency with respect to the geometric structure and the temporal structure of the actual data by using a device having a complexity that is closer to a neuron. The hardware emulator may utilize reconstruction based on the RNN 220 to extract a local model of data for completely reconstructing the geometric and temporal features of the neural data. For example, the neural data may be used for training the RNN by using the temporal data as an input and the reconstructed state space representation as a portion of a loss function of the RNN 220.

According to an embodiment, the RNN 220 may be used in a specific implementation for various reasons. One of the reasons may be that the RNN 220 is a model that is able to completely reconstruct temporal dynamics due to its ability to maintain the memory of previous inputs. Another reason may be that the RNN 220 is represented or approximated by using a differential equation and this is used for imposing dynamics of the memristor-based circuit.

For example, the RNN 220 used for imposing dynamics of the memristor-based circuit may be implemented by considering a hidden state of the RNN 220 that captures information on the previous input history of a sequence as Equation 1.

$$ht - f ( W . ht - 1 + U . xt + b ) \qquad [ Equation 1 ]$$

In this case, ht may denote a hidden state of the RNN 220, xt may denote an input of a time t, W may denote a weight matrix corresponding to the hidden state ht, U may denote a weight matrix corresponding to the input x, b may denote a bias vector and f may denote a nonlinear activation function.

According to an embodiment, a method of approximating the RNN 220 may include regarding the hidden state ht as a continuous function that changes over time. For example, an RNN-ODE may consider that hidden state evolution is governed by a time continuous dynamical system as Equation 2 shown below.

$$\frac{dh ( t )}{dt} = F ( h ( t ) , x ( t ) , t ) \qquad [ Equation 2 ]$$

In this case, ht may be regarded as a continuous function, x(t) may denote input features that are able to continuously change over time and F may encapsulate network dynamics. For example, F may be parameterized by a neural network itself.

In an embodiment, a memristor-based circuit (or a memristive circuit) may be designed by reflecting a dynamic behavior using an approximated ODE as an input in the trained RNN 220model.

The hardware emulator may find starting values of an auxiliary circuit (or elements of the auxiliary circuit) using simulation (e.g., PSpice) based on the memristor-based circuit. For example, the hardware emulator may fine-tune parameters of the elements directly in the hardware in real-time by changing parameters of the elements (e.g., a capacitor, a resistor, etc.) until the high-fidelity emulation of the neural data is achieved.

For example, the hardware emulator may emulate the state space representation by flux control using the Wien bridge oscillator or the cellular neural network. The flux control using the Wien bridge oscillator or the cellular neural network may be an approach scheme without an inductor, and thereby, the implementation may be easy.

FIG. 3 is a schematic diagram of an operation of a memristor-based circuit according to some embodiments. Referring to FIG. 3, a diagram 300 illustrates an operation of a memristor-based circuit according to various complexities in a hardware emulator.

According to an embodiment, the memristor-based circuit may include a memristor circuit or a memristor array and may include dynamic features observed in a neuron. For example, the dynamic features may correspond to a result from 0th complexity to fourth-order complexity corresponding to a synaptic feature 330 and/or a neuron feature 350. In some embodiments, the synaptic feature 330 may be referred to as a synaptic property and/or the neuron feature 350 may be referred to as a neuron feature 350.

In an embodiment, neural data may be replicated by applying dynamics to a neural network model assuming a memristive circuit.

In an embodiment, a neuroscientific discovery process and subsequent development of a general model may be enabled by completely duplicating a neuroscientific experiment (e.g., operations of synapses and neurons 310 shown in the diagram 300) as the synaptic feature 330 and the neuron feature 350 by the hardware emulator.

The synapses and neurons 310 constituting a cellular neural network may include a dendrite, an axon, and a synapse. The dendrite may continue to various branches and may mainly correspond to a portion in which a nerve cell (neuron) receives a signal. The dendrite may spread in various directions and may receive various stimuli. An axon may be a portion extending from a cell body and may transmit a signal to another nerve cell or a cell. An axon may be connected to an end of a synapse and may interact with another nerve cell through the synapse. The synapse may correspond to a structure formed by a connection between two adjacent nerve cells. The synapse may process and transmit information by transmitting an electrochemical signal. The cellular neural network may perform complex information processing through connection and communication between neurons and may adjust various functions, such as learning, memory, sensation, and motion.

According to an embodiment, the synaptic feature 330 may include, for example, directional conduction, synaptic delay, excitation and inhibition, short-term plasticity, long-term plasticity, spatio-temporal convergence and summation, and synaptic reverberation. However, the example is not limited thereto.

In addition, the neuron feature 350 may include, for example, integrate and fire, periodic action potential, spike number adaptation, periodic bursting, burst number adaptation, chaotic oscillation, and hyperchaos. However, the example is not limited thereto.

The hardware emulator may replicate operations of synapses and neurons based on data observed in the synapses and neurons 310.

In an embodiment, an artificial neural network model (e.g., the RNN 220) may be inferred by a measurement value observed by the synapses and neurons 310 and the inferred artificial neural network model may function as an emulator of a given experiment. The hardware emulator may accurately reconstruct a state space representation measured from set data.

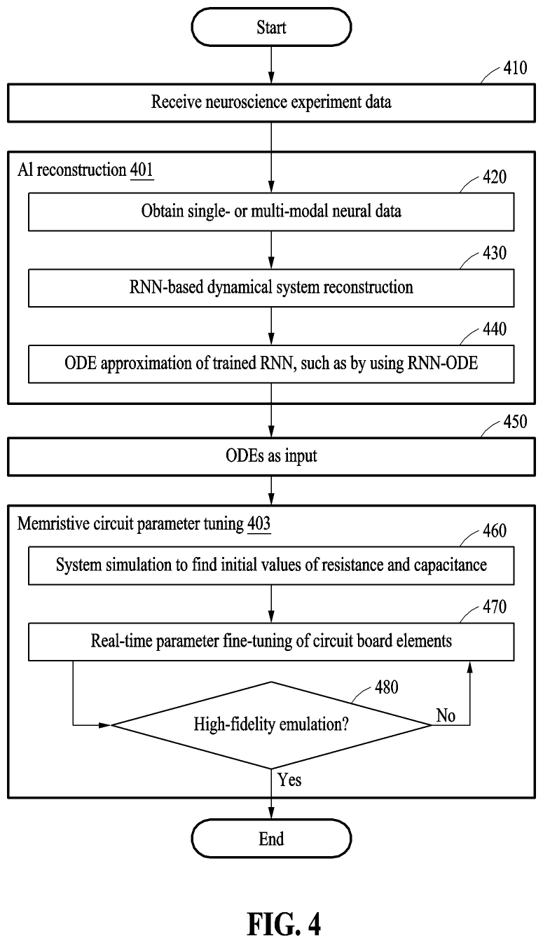

FIG. 4 is a diagram illustrating an operation process of a hardware emulator according to an embodiment. FIG. 4 is a flowchart illustrating an implementation process of a hardware emulator according to an embodiment. In an embodiment, an implementation process of a hardware emulator is described with reference to FIG. 4. However, the example is not limited thereto and the same method may apply to the implementation of a software emulator.

In operation 410, the method may include receiving neuroscience experiment data. For example, a hardware emulator may receive neuroscience experiment data 410 as an input. The hardware emulator may be mainly implemented through a reconstruction process 401 of AI based on an artificial neural network (e.g., an RNN) and a parameter tuning process 403 of a memristor-based circuit, wherein the parameter tuning process 403 is performed based on an ODE that is output (or approximated) from the reconstruction process 401.

According to an embodiment, the method may include a reconstruction process 401 and a parameter tuning process 403. In the reconstruction process 401 may include operations 420 to 440 and in the parameter tuning process 403 may include operations 460 to 480. However, the disclosure is not limited to the operations or the order of the operations illustrated in FIG. 4. As such, according to another embodiment, one or more of operation may be added, omitted or combined.

In operation 420, the method may include obtaining neural data. For example, the hardware emulator may obtain neural data. The neural data may include single-model neural data and/or multi-modal neural data.

In operation 430, the method may include reconstructing a dynamical system based on the obtained neural data. For example, the hardware emulator may reconstruct a dynamical system based on an RNN using the neural data obtained in operation 420. The neural data may be reconstructed based on the RNN. The hardware emulator may train the RNN such that the neural data accurately reconstructs dynamics of the given dynamical system.

In operation 440, the method may include approximating an ODE based on the trained RNN. For example, the hardware emulator may approximate an ODE by the trained RNN in operation 430. For example, the trained RNN may be an RNN with ordinary differential equations (RNN-ODE). However, the example is not limited thereto. The RNN-ODE may be a technique developed to model time series data that is irregularly sampled and may process time series data having an irregular interval that is difficult to process by a typical RNN. The RNN-ODE may have a hidden state defined in a continuous time and thereby, may enable more flexible modeling than a discrete state of the typical RNN. The RNN-ODE may model a dynamic change in the hidden state using a differential equation and through this, may depict a continuous change in the time series data. In addition, the RNN-ODE may stochastically model an observation time interval. For example, the RNN-ODE may infer the probability of observation time using a Poisson process.

Once the trained RNN in operation 430 is able to accurately reconstruct dynamics of the given dynamical system, the reconstructed dynamical system may be approximated by an ODE set, which functions as an input to design a memristor circuit in the following parameter tuning process 403 through operation 440.

In operation 450, the method may include inputting the ODE to the memristor-based circuit for performing the parameter tuning process 403. For example, the hardware emulator may input the ODE, which is output (or approximated) in the reconstruction process 401, to the memristor-based circuit performing the parameter tuning process 403. Operations 460 to 480 below may be performed on the memristor-based circuit of the hardware emulator.

In operation 460, the method may include performing simulation (or emulation) to find initial values of elements. For example, the hardware emulator may perform simulation (or emulation) to find initial values of elements (e.g., a resistance and a capacitance) included in the memristor-based circuit.

In operation 470, the method may include fine-tuning the elements. For example, the hardware emulator may fine-tune the elements (e.g., the resistance and capacitance, etc.) of the memristor-based circuit in real-time by using the found initial values of the elements according to a simulation (or emulation) result in operation 460.

In operation 480, the method may include determining whether the emulation according to the fine-tuning result corresponds to high-fidelity emulation. For example, the hardware emulator may determine whether the emulation according to a fine-tuning result in operation 470 corresponds to high-fidelity emulation. For example, the emulator may determine whether the emulation corresponds to high-fidelity emulation based on whether the emulation satisfies a criterion. For example, the emulator may determine whether the emulation is higher than a reference value.

In operation 480, based on a determination that the emulation corresponds to the high-fidelity emulation higher than the predetermined criterion, the hardware emulator may terminate an operation.

On the other hand, based on a determination that the emulation does not correspond to the high-fidelity emulation higher than the predetermined criterion, the hardware emulator may iteratively perform fine-tuning on the elements of the memristor-based circuit until the fidelity of emulation exceeds the predetermined criterion through operation 470. For example, based on a determination that the fidelity of emulation is less than the predetermined criterion the hardware emulator may iteratively perform fine-tuning on the elements of the memristor-based circuit until the fidelity of emulation exceeds the predetermined criterion.

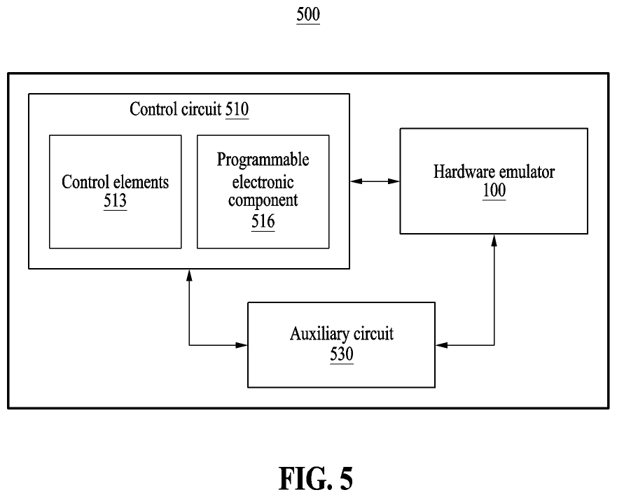

FIG. 5 is a block diagram of an emulation system according to an embodiment. Referring to FIG. 5, an emulation system 500 in an embodiment may include a control circuit 510 and the hardware emulator 100. In addition, the emulation system 500 may further include an auxiliary circuit 530.

The control circuit 510 may include control elements 513 and a programmable electronic component 516. For example, the control circuit 510 may adjust the control of the emulation system 500 to replicate an operation of neural data using the control elements 513 in real-time. In this case, the “programmable electronic component” may be an integrated circuit including an array of a transistor-based logic gate and may correspond to a semiconductor element that is able to re-implant a circuit to suit its purpose. The programmable electronic component may be, for example, a field-programmable gate array (FPGA), but the example is not limited thereto.

The control circuit 510 may perform fine-tuning on the hardware emulator 100 by changing parameters of the control elements 513 until the fidelity of emulation for the neural data exceeds a predetermined criterion. The control elements 513 may include, for example, at least one of a CMOS resistor, a varactor, and a transistor, but the example is not limited thereto.

The hardware emulator 100 may be based on a memristor and may emulate dynamics observed in the neural data by the control adjusted by the control circuit 510.

The emulation system 500 may further include the auxiliary circuit 530 performing at least one of power management, communication, and auxiliary communication for at least one of the programmable electronic component 516 and the memristor-based circuit of the hardware emulator 100.

For example, the emulation system 500 may be controlled by considering at least one of the dynamic complexity of the neural data, desired accuracy and latency for operation replication of the neural data, ease of reconfiguration, and the order of complexity of a memristive element configuring the memristor-based circuit.

For example, the emulation system 500 may be included in at least one of a wafer monitoring device, a video synthesis and analysis device, an audio synthesis and analysis device, a robot device, a home appliance product, and a communication device, but the example is not limited thereto.

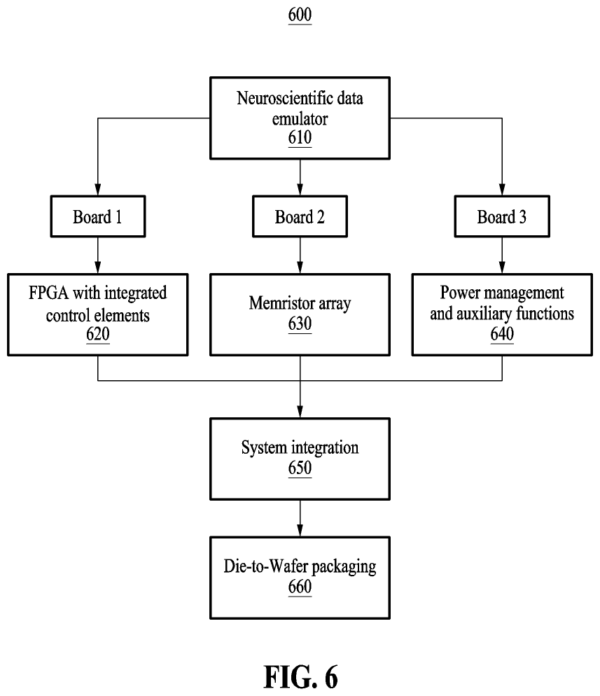

FIG. 6 is a diagram illustrating a production process of an emulation system according to an embodiment. Referring to FIG. 6, a diagram 600 illustrating three boards (or chiplets) configuring an emulation system 610 based on neuroscience experiment data according to an embodiment is illustrated.

In an emulation, an emulation system 610 may be configured by three boards (e.g., a board 1 620, a board 2 630, and a board 3 640) by considering the difficulty of manufacturing for monolithically integrating a memristive device, a varactor, a resistor, and a power management element. However, the disclosure is not limited to the number of boards illustrated in FIG. 6.

The board 1 620 may correspond to a programmable electronic component (e.g., an FPGA) including integrated control elements (e.g., a CMOS resistor, a varactor, and a transistor). The board 1 620 may adjust dynamical system control in real-time to replicate a desired operation extracted from the neural data. The board 2 630 may correspond to a memristor array. The board 2 630 may correspond to a dedicated board for a device that actively emulates complex dynamics observed in the neural data. The board 3 640 may perform power management and auxiliary functions. The board 3 640 may perform, for example, power management, communication, and auxiliary communication (e.g., Ethernet, universal serial bus (USB)) functions. The three boards 620, 630, and 640 may be integrated into a single emulation system 650.

The integrated single emulation system 650 may be packaged by, for example, die-to-wafer (D2W) bonding. The D2W bonding may be a process of bonding a die (a chip) to a wafer and may be used to bond two different materials, which are metal and dielectric. In this case, the metal may be, for example, copper (Cu), and the dielectric may be, for example, an oxide film (SiO2). However, the example is not limited thereto.

According to another embodiment, the integrated single emulation system 650 may be packaged using, for example, other wafer level packing (WLP) techniques, such as chip-to-wafer (C2W) bonding or system-in-package (SiP).

The C2W bonding may be a technique for connecting a die (a chip) to a wafer and may be operated by disposing a die on a wafer and connecting them vertically through a copper pad. The C2W bonding may be, for example, used in various application fields including an image sensing field, and may improve the connection between a die and a wafer and may efficiently connect a die having various functions.

The SiP may refer to a single independent function by stacking or arranging multiple chips in one package. The SiP may be used to configure a complex system in a small and efficient form by integrating multiple independent integrated circuits (ICs) into one package.

For example, the emulation system 650 may be implemented by depending on the dynamic complexity of the neural data, desired accuracy and latency, ease of reconfiguration, and the order of complexity of a memristive element, but the example is not limited thereto.

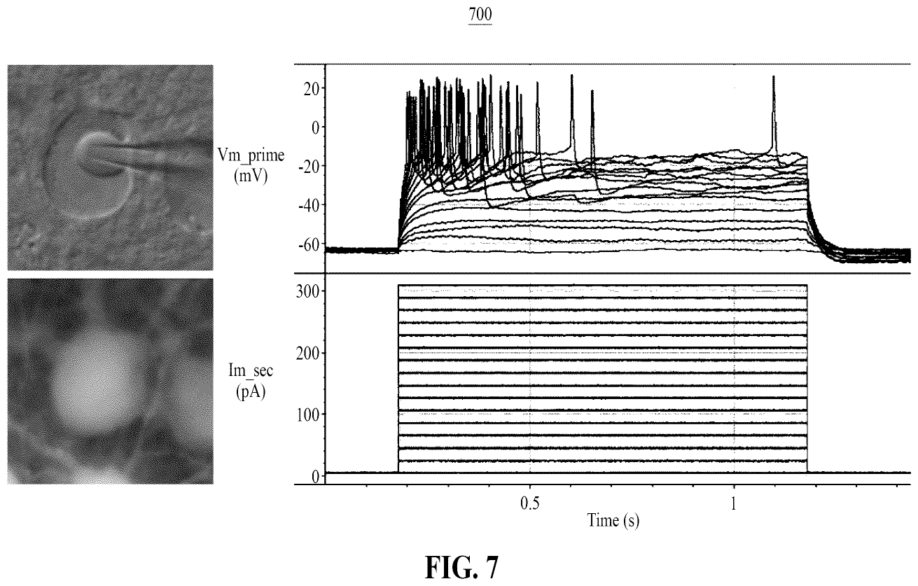

FIG. 7 is a diagram illustrating input data obtained by recording activities of individual neurons. Referring to FIG. 7, a diagram 700 representing recorded data of a patch clamp of a single neuron for various excitation conditions is illustrated.

The patch clamp may correspond to an electrophysiological technique for studying an activity of an ion channel. The patch clamp may correspond to a technique of measuring a current of an ion channel by inserting a fine electrode into a cell membrane and analyzing a behavior of the ion channel through the measured current of the ion channel. For example, the patch clamp may be used for studying an activity of an ion channel in various cells, such as a neuron, a muscle cell, and a myocardial cell. A function of an ion channel, control mechanism, and a medication effect may be understood through the patch clamp data and an analysis thereof.

For example, the recorded data of the patch clamp may be obtained by recording voltage data or current data obtained by conducting a patch clamp experiment through an amplifier and a digitizer. The recorded data of the patch clamp may be obtained by removing noise from the data obtained through the patch clamp experiment and refining the data by setting a required range and/or may be obtained by optimizing the data using a filtering technique.

Since the patch-clamp recording of a single neuron as shown in FIG. 7 requires a large volume of experiment processing, the patch-clamp recording of a single neuron may correspond to an experiment that is time-consuming and difficult to reproduce. However, the hardware emulator and/or the emulation system in an embodiment may conduct a wide range of experiments before repeating an actual biological experiment by emulating the currently obtained neural data for a brain recording platform.

According to an embodiment, data may be collected by using the hardware emulator and/or the emulation system, data analysis and hypothesis generation may be performed based thereon, and an experiment for evaluating the hypothesis may be conducted.

The hardware emulator and/or the emulation system may accelerate the development speed of a computer system and AI inspired by the brain and a neuroscience research result by accelerating a cycle of hypothesis generation and verification until a new neuroscience experiment is inevitable by the memristor-based circuit.

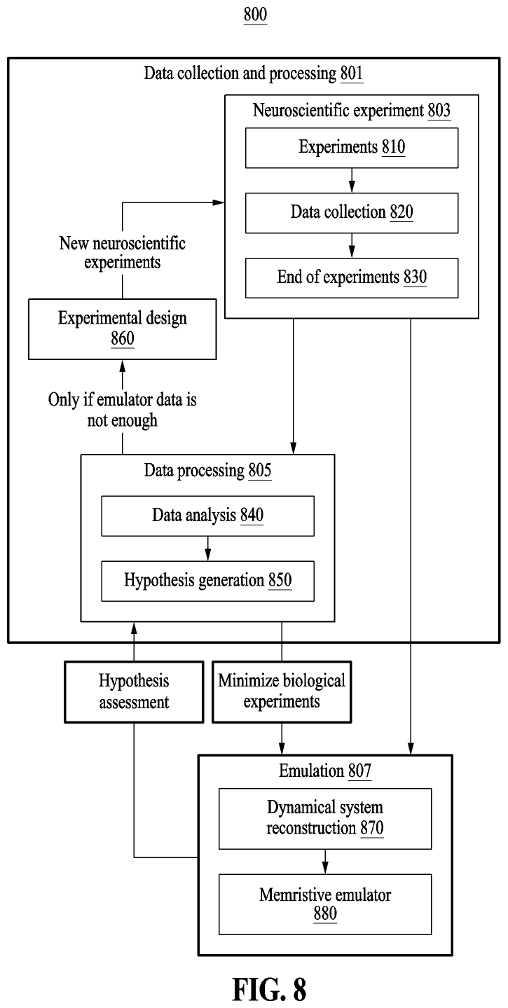

FIG. 8 is a diagram illustrating an operation of an emulation system according to an embodiment. Referring to FIG. 8, an operation of an emulation system according to an embodiment may include a data collection and processing process 801 and a emulation process 807.

The data collection and processing process 801 may be performed through a data collection process 803 of a neuroscience experiment and a data processing process 805.

In the data collection process 803 of the neuroscience experiment, data corresponding to an experiment result may be collected through experiment 810, data collection 820, and experiment termination 830 processes. The data collected in the data collection process 803 may be used as input data in the data processing process 805 and the emulation process 807.

The data collected in the data collection process 803 may be transmitted to the emulation process 807 and may be used for the design of an emulator including a memristor-based circuit.

In an example case in which the data collected in the data collection process 803 is transmitted, in the data processing process 805, a data analysis 840 and hypothesis generation 850 may be performed. In an example case in which a volume of data processed in the data processing process 805 is not sufficient to perform emulation in the emulation process 807, the data collection process 803 for a new neuroscientific experiment may be iteratively performed through experimental design 860.

In an example case in which a volume of data processed in the data processing process 805 is sufficient to perform emulation in the emulation process 807, the data processed in the data processing process 805 may be transmitted to the emulation process 807. In this case, the data transmitted to the emulation process 807 through the data processing process 805 may be data that minimizes biological experiments.

In the emulation process 807, dynamical system reconstruction 870 and a memristor-based emulator 880 may be implemented using the data transmitted through the data processing process 805 and/or the data collected through the data collection process 803.

An emulation result performed in the emulation process 807 may be transmitted to the data processing process 805 and may be used for hypothesis assessment.

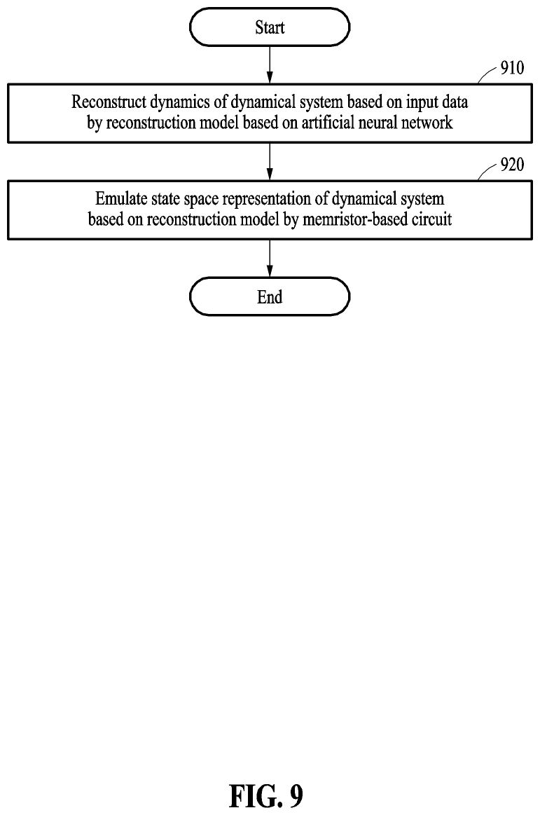

FIG. 9 is a flowchart illustrating an operating method of a hardware emulator according to an embodiment. Referring to FIG. 9, the hardware emulator in an embodiment may include a reconstruction model based on an artificial-neural network and a memristor-based circuit, and may emulate a state space representation of a dynamical system through operations 910 and 920.

The hardware emulator, the reconstruction model, and the memristor-based circuit may correspond to, for example, the hardware emulator 100, the reconstruction model 110, and the memristor-based circuit 130 shown in FIG. 1. However, the example is not limited thereto.

In operation 910, the method may include reconstructing dynamics of a dynamical system based on input data. For example, the hardware emulator may reconstruct dynamics of a dynamical system based on input data by the reconstruction model based on the artificial neural network.

In operation 920, the method may include emulating a state space representation of the dynamical system based on the reconstruction model. For example, the hardware emulator may emulate a state space representation of the dynamical system based on the reconstruction model by the memristor-based circuit.

According to an embodiment, the blocks that are referred to as units may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

Although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

What is claimed is:

1. A hardware emulator comprising:
a reconstruction model based on an artificial neural network, the reconstruction model configured to reconstruct a dynamic system based on input data; and
a memristor-based circuit configured to emulate state space representation of the dynamic system based on the reconstruction model.

2. The hardware emulator of claim 1, wherein the reconstruction model is further configured to reflect one or more features of the dynamic system in the memristor-based circuit by approximating the artificial neural network based on a differential equation.

3. The hardware emulator of claim 2, wherein the reconstruction model is further configured to approximate the artificial neural network based on a hidden state of the artificial neural network.

4. The hardware emulator of claim 1, wherein the reconstruction model is further configured to reconstruct a geometric feature of the input data.

5. The hardware emulator of claim 1, wherein the hardware emulator is configured to emulate the state space representation based on an ordinary differential equation (ODE) approximated by the reconstruction model.

6. The hardware emulator of claim 5, wherein the hardware emulator is further configured to:
perform emulation to find initial values of elements of the memristor-based circuit based on the ODE, and
fine-tune the elements in real-time based on the initial values of the elements.

7. The hardware emulator of claim 6, wherein the hardware emulator is further configured to iteratively perform fine-tuning on the elements until fidelity of the emulation satisfies a criterion.

8. The hardware emulator of claim 6, wherein the hardware emulator is further configured to emulate the state space representation by flux control using at least one of a hardware oscillator or a cellular neural network.

9. The hardware emulator of claim 8, wherein the hardware emulator is further configured to emulate the state space representation by mapping a hidden state of the artificial neural network onto the cellular neural network.

10. The hardware emulator of claim 8, wherein the hardware emulator is further configured to fine-tune elements of the memristor-based circuit using a set of normalized differential equations by a chaotic attractor implemented by the hardware oscillator.

11. The hardware emulator of claim 1, wherein the artificial neural network is trained based on temporal data and the state space representation as a portion of a loss function.

12. The hardware emulator of claim 1, wherein the hardware emulator is configured to reflect a dynamic behavior of the dynamic system in the memristor-based circuit based on an ordinary differential equation (ODE) approximated in the reconstruction model as an input.

13. The hardware emulator of claim 1, wherein the hardware emulator is configured to reconstruct temporal dynamics of the input data using the artificial neural network, which maintains memory about the input data.

14. The hardware emulator of claim 1, wherein the hardware emulator is configured to reflect one or more features of the dynamic system in the memristor-based circuit based on a hidden state of the artificial neural network that captures previous input data of the input data.

15. An emulation system comprising:
a control circuit comprising a plurality of control elements including a programmable electronic component, the control circuit configured to adjust control of the emulation system in real-time to replicate an operation of neural data by using the plurality of control elements; and
a memristor-based hardware emulator configured to emulate one or more features in the neural data based on the control of the emulation system by the control circuit.

16. The emulation system of claim 15, wherein the control circuit is further configured to perform fine-tuning on the memristor-based hardware emulator by changing parameters of the plurality of control elements until fidelity of emulation for the neural data exceeds a reference value.

17. The emulation system of claim 15, wherein the plurality of control elements comprise at least one of a complementary metal-oxide-semiconductor (CMOS) resistor, a varactor, or a transistor.

18. The emulation system of claim 15, further comprising:
an auxiliary circuit configured to perform at least one of power management, communication, or auxiliary communication on at least one of the programmable electronic component or a memristor-based circuit of the memristor-based hardware emulator.

19. The emulation system of claim 15, wherein the emulation system is comprised in at least one of a wafer monitoring device, a video synthesis and analysis device, an audio synthesis and analysis device, a robot device, a home appliance product, or a communication device.

20. An operating method of a hardware emulator including a reconstruction model based on an artificial neural network and a memristor-based circuit, the operating method comprising:
reconstructing a dynamic system based on input data by the reconstruction model based on the artificial neural network; and
emulating a state space representation of the dynamic system based on the reconstruction model by the memristor-based circuit.
